(19) United States
(12) Patent Application Publication
(10) Pub. No.: US 2011/0131020 A1
(43) Pub. Date: Jun. 2, 2011

(54) DIP GUIDED FULL WAVEFORM INVERSION

(75) Inventor: Zhaobo MENG, Katy, TX (US)

(73) Assignee: CONOCOPHILLIPS COMPANY, Houston, TX (US)

(21) Appl. No.: 12/878,607

(22) Filed: Sep. 9, 2010

Related U.S. Application Data
(60) Provisional application No. 61/240,794, filed on Sep. 9, 2009.

(51) Int. Cl. G06F 17/10

(52) U.S. Cl. 703/2

(57) ABSTRACT

A method of determining seismic data velocity models comprising dip-guided full waveform inversion that obtains a better velocity model with less computational requirements. DG-FWI quickly converges to provide a better image, obtains better amplitudes, and relies less on lower frequencies. Improved image quality allows detailed seismic analyses, accurate identification of lithological features, and imaging near artifacts and other anomalies.

### CROSS-REFERENCE TO RELATED APPLICATIONS

This application is a non-provisional application which claims benefit under 35 USC §119(e) to U.S. Provisional Application Ser. No. 61/240,794 filed Sep. 9, 2009, entitled “DIP GUIDED FULL WAVEFORM INVERSION,” which is incorporated herein in its entirety.

### STATEMENT REGARDING FEDERALLY SPONSORED RESEARCH

None.

### FIELD OF THE DISCLOSURE

The present disclosure generally relates to dip-guided full waveform inversion (DG-FWI) that combines dip-guide methodology (Hale, 2009) with the full waveform inversion (FWI) process (e.g. Bunks, et al., 1995; Pratt, 1999) to obtain a dimension reduction technique (e.g. Yang & Meng, 1996) that can greatly reduce difficulties encountered in FWI.

### BACKGROUND OF THE DISCLOSURE

Full waveform inversion (FWI), is a well studied and extensively published subject (e.g. Bunks, et al., 1995; Pratt, 1999). Recent technical developments have shown that seismic velocities produced by FWI can produce high resolution detail. This detail can provide valuable attributes for the purposes of depth imaging, pore pressure prediction and stratigraphic description. FWI utilizes an inversion method adjusting the trial velocity model to match the synthetic wavefield and the recorded wavefield through a forward modeling process. However, despite the significant potential, it has been challenging to apply this technique, which may be formulated in either time (Lailly, 1983; Tarantola, 2005) or frequency domains (Pratt, 1999 a & b), on full-scale 3D models.

Carrazzone and associates, U.S. Pat. No. 5,583,825, use pre-stack seismic reflection data at a subsurface calibration location to derive lithology and fluid content at a subsurface target location. Cross and Lessenger, U.S. Pat. No. 6,246,963, use a mathematical inverse algorithm to modify values of process parameters to reduce the differences between initial model predictions and observed data until an acceptable match is obtained. In U.S. Pat. No. 6,980,254, Nishihashi and associates use an image interpolation system where virtual interpolation data generate data for inter-lines between the lines of the input image that extracts matching patterns. Perez, et al., U.S. Pat. No. 6,856,705, provide a blended result image using guided interpolation to alter image data within a destination domain. Saltzer and associates, U.S. Pat. No. 7,424,367, predict lithologic properties and porosity of a subsurface formation from seismic data by inverting the seismic data to get bulk elastic properties across the subsurface formation; a rock physics model of the subterranean formation is constructed and builds a fluid fill model indicating the type of fluid present at each location in the subsurface. In U.S. Pat. No. 7,480,206, Hill uses energy components like velocity and shape to create an energy lens model where seismic targets are updated by transforming an energy component through the energy lens model.

Sherrill and Mallick, U.S. Pat. No. 7,373,252, improve upon existing pre-stack waveform inversion (PSWI) by generating a macro P-wave velocity model using reflection tomography, comparing the macro P-wave velocity model to the seismic data set, and updating the macro P-wave velocity model iteratively. In U.S. Pat. No. 7,254,091, Gunning and associates simulate spatial dispersion within a layer of the seismic inversion by vertically subdividing the layer and modeling the layer consistently with a vertical average including Bayesian updating to estimate and reduce uncertainty in a reservoir model. Tnacheri and Bearnth, U.S. Pat. No. 7,519,476, use geopopulation and genotype analysis to model reservoir features by analyzing a series of properties (genotype) simultaneously.

Full wave form inversions (FWI) are difficult to perform, simulating large quantities of data, and require a large amount of processing to achieve a final model that incorporates lithology in the seismic data. Foster and Evans (2008) provide a recent evaluation of FWI for geophysical applications. The methods described above reduce the amount of data analyzed, analyze data in larger blocks, layers, or levels that do not mimic the lithology of the system. These methods also generalize and require multiple iterations to identify the “correct” model that fits the data. Because many of these methods sample the data in a uniform and unweighted manner, changes in the data and the underlying lithology may be overlooked by these models.

A method of seismic data modeling is required that accurately identifies the underlying lithology of the formation while minimizing the misfit between the modeled data and the recorded data. This is complicated by noise in the seismic data and artifacts within the data that obscure the true lithology. To increase resolution and obtain data within areas with artifacts a method is required that addresses problems concealed within the inversion procedure including convergence speed, number of iterations required for convergence, determining correct inversion model as there are multiple different models that may represent the data, and removing amplitude and non-linearity problems associated with the current techniques.

### BRIEF DESCRIPTION OF THE DISCLOSURE

In order to overcome the difficulties of FWI, a method using dip-guide methodology with the full waveform inversion process, or “dip-guided full waveform inversion” (DG-FWI) is utilized to generate velocity models. The process is two-fold, using Hale's (Hale, 2009) image-guided interpolation methodology and a revised FWI methodology with a DG-FWI approach which incorporates dimension reduction techniques (e.g. Yang & Meng, 1996) that can greatly reduce the difficulties encountered in FWI, both incorporated by reference. The DG-FWI reduces the size of the inversion and the computational cost while it mitigates some of FWI's shortcoming with respect to the dependence on the very low-frequency seismic data; and generally improves model convergence.

The term “dip-guide” is also referred to as “image-guided interpolation” or “blended neighbor interpolation” introduced by Hale (Hale, 2009). Hale's image-guided interpolation is designed specifically to enhance the process of interpolation of properties at locations some distance from boreholes by use of the dip information gained from the image.

Velocity models were developed by: a) obtaining seismic data, b) calculating the misfit gradient by back-projecting the residual with respect to the model, c) preparing a dip-guide from the seismic data, d) preparing measurement points, e) calculating the misfit gradient with respect to the measurement points, and f) developing a full waveform inversion model using the dip-guide, wherein the dip-guide (tensor field) is used to condition full waveform inversion. Steps (b) through (f) may be repeated one or more iterations to improve forward model resolution. Additionally, steps (d), (e), and (f) may be repeated to further sharpen forward model resolution.

Alternatively, velocity models were developed by: a) obtaining seismic data, b) calculating the misfit gradient by back-projecting the residual with respect to the model, c) preparing a dip-guide from the seismic data, d) preparing measurement points, e) calculating the misfit gradient with respect to the measurement points, f) developing a full waveform inversion model using the dip-guide, and g) repeating steps (b), (c), (d), and (e) wherein the dip-guided inversion model provides an initial model for full waveform inversion. Additionally, steps (d), (e), and (f) may be repeated to further sharpen forward model resolution.

The above velocity models may be developed by a) obtaining seismic data on a computer readable media, b) transferring the seismic data to a velocity analysis system, c) calculating dip-guide from the seismic data, d) performing a full waveform inversion model using the dip-guide (tensor field) in the velocity analysis system, wherein the dip-guide is used to condition full waveform inversion.

Seismic data may be obtained from any number of sources including recent seismic surveys, databases of past seismic surveys and commercial databases with a variety of data types including but not limited to seismic data, velocity models, tomography surveys, and the like.

The misfit gradient may be calculated by back-projection of the residual error between the original data and the current velocity model. A misfit gradient may also be obtained that uses additional information including seismic models from a variety of disciplines, fracture analysis studies, and the like.

The dip-guide may be calculated as the tensor field that represents the underlying seismic data. Measurement points are identified from the dip-guide at changes in the tensor field. The dip-guided inversion model may be represented by mₖ=Φxₖ or Δmₖ=ΦΔxₖ, where k is the iteration index. The forward model is analyzed for changes in the misfit gradient and the full waveform inversion is repeated 1 or more times to improve forward model resolution. The forward model will help resolve anomalies in the seismic data including low velocity zones, high velocity zones, gas zones, salt zones, or other features. Changes in misfit gradient may be monitored for migration from iteration to iteration. Velocity modeling can be used on seismic data from refraction tomography, surface reflection tomography, transmission tomography, previously developed models and/or more other seismic studies. Full waveform modeling iterations are reduced by dip-guided inversion modeling when compared to full waveform modeling alone. Dip-guided inversion modeling may reduce the processing and/or time requirements by 2-20 fold. Dip-guided inversion modeling has been shown to reduce processing and/or time by 5-10 fold, and can reduce the processing and/or time by greater than 8 fold. A variety of commercial and privately developed velocity analysis systems can be used for dip-guided inversion modeling including 3D Model Builder, Seismitarium, ModSpec, Vest3D, Velocity Model Building (VMB), and reflection tomography.

### BRIEF DESCRIPTION OF THE DRAWINGS

FIG. 1: Synthetic models. FIG. 1 through FIG. 6 show the mechanism of DG-FWI through a synthetic data. FIG. 1A shows the true velocity while FIG. 1B shows the initial velocity. The true velocity model includes a V(z) model referenced on the water bottom, a deeper flat reflector and anomalies. The anomalies consist of a low velocity gas zone (LVZ) and the high velocity bar (HVB). While the initial velocity model does not include the anomalies. In the data, there are 148 shots with shot spacing of 60 ft and receiver spacing of 30 ft. Depth spacing is 30 ft, and dominant frequency is 10 Hz. The chosen frequency 10 Hz is intentionally slightly higher than desirable for FWI, however it is designed to test the robustness of the DG-FWI methodology. FIG. 1C shows the difference between the true velocity model and the initial velocity model.

FIG. 2: Forward modeling results and misfit gradient. Demonstrates forward modeling and misfit gradient with an FWI analysis. FIG. 2A shows a sample shot with the true velocity model FIG. 1A. FIG. 2B shows a sample shot with the initial velocity model FIG. 1B, which only generates the reflection from the deeper flat reflector. FIG. 2C shows the misfit gradient obtained by solving the adjoint system of the forward modeling. In this synthetic test, FIG. 2C will be used to calculate the dip guide.

FIG. 3: FWI results with 1, 5 and 20 iterations. FIG. 3A shows the velocity perturbation (ΔV) after one iteration, FIG. 3B shows the ΔV after 5 iterations, and FIG. 3C shows the ΔV after 20 iterations of inversion. Clearly the FWI is struggling to converge to the true solution of FIG. 1C, maybe due to the lack of low frequencies in the synthetic dataset (with high dominant frequency of 10 Hz). FIG. 3D shows the forward modeling results after 5 iterations of FWI, indicating there are a lot of discrepancies generated, compared to the true wavefield FIG. 2A.

FIG. 4: Dip guide, DG-FWI inversion results. FIG. 4A, first of all, shows the dip guide (namely the tensor field) displayed as ellipses calculated from the misfit gradient FIG. 2C; secondly, 6 measurement points are used and marked as the red crosses. Next, FIG. 4B is generated by one iteration of DG-FWI, which is already close to the true velocity perturbation ΔV as shown in FIG. 1C. Then, FIG. 4C shows the result with one iteration of DG-FWI followed an extra one iteration of FWI, which gives better result than a DG-FWI alone (FIG. 4B). The extra FWI following the DG-FWI in fact brings in some sharp boundaries. This latter strategy has been recommended in the workflow. It is worth mentioning that to obtain the best result of FIG. 4C, only 2 iterations (one DG-FWI and one FWI) of forward modeling and inversion are required, which converges much faster than the FWI (FIG. 3A, 3B, 3C).

FIG. 5: Forward modeling results. Data fitting between the FWI and DG-FWI methodologies, FIG. 5A (the same as FIG. 2A), shows the true data while FIG. 5B shows the modeling data from the best DG-FWI model obtained in FIG. 4C. To compare with a FWI model, FIG. 5C shows the data residual between the true data FIG. 5A and the modeling data from a FWI model FIG. 3C; in comparison with FIG. 5D showing the data misfit residual between the true data FIG. 5A and the modeling data FIG. 5B. Clearly the DG-FWI residual FIG. 5D diminishes while the FWI residual FIG. 5C hardly converges to zero.

FIG. 6: Reverse time migration comparisons. FIG. 6A-6C show the RTM (reverse time migration) image comparison derived from the DG-FWI and FWI velocity models. FIG. 6A shows the RIM image migrated from the initial velocity model FIG. 1B; FIG. 6B shows the RTM image migrated from the FWI model FIG. 3B and FIG. 6C shows the RTM image migrated from the DG-FWI model FIG. 4C. Clearly the DG-FWI model FIG. 4C produces the best image. In particular, the deepest reflector in FIG. 6C is perfectly flat, while that in FIGS. 6A and 6B are not flat.

FIG. 7 Field data comparisons. FIGS. 7 and 8 show the DG-FWI through a difficult imaging area. FIG. 7A shows the starting velocity model; FIG. 7B shows the RTM image migrated from the starting velocity model FIG. 7A, overlain by the dip guide calculated from the image; FIG. 7C shows the updated model after one DG-FWI followed by one FWI; FIG. 7D shows the RTM image after 8 FWIs; and FIG. 7E shows the RTM image after one DG-FWI and one FWI. There are visible improvements in the images in FIG. 7E over FIG. 7D. The improved image of FIG. 7E by DG-FWI only takes ¼ run time of FIG. 7D by pure FWI.

FIG. 8 Kirchhoff Gathers comparisons. FIG. 8A shows the Kirchhoff gathers close to an obscured zone migrated using the pure FWI model (FIG. 7D) and FIG. 8B shows the Kirchhoff gathers migrated using the DG-FWI model (FIG. 7E). Overall gathers are flatter in FIG. 8B in most areas. The DG-FWI produces superior results with ¼ of the computing costs of the pure FWI.

### DETAILED DESCRIPTION OF EMBODIMENTS OF THE INVENTION

In essence, the present invention DG-FWI provides a dip guide (DG) to constrain the full waveform inversion (FWI). The dip guide is calculated using Hale's methodology (Hale, 2009) which can greatly reduce the size of the FWI. This reduces the dimension of the inversion and improves the convergence greatly (e.g. Yang & Meng, 1992).

Vienot and associates, U.S. Pat. No. 5,835,882 incorporated by reference, use both seismic and petrophysical data to determining flow characteristics within a reservoir layer, by assigning a numerical connectivity factor (CF) to subvolumes within the volume, averaging planar connectivity factors for simulation cells of 4 or more subvolumes; where the numerical flow values for the simulation cells demonstrate flow barriers within said reservoir layer. In U.S. Pat. No. 5,835,883, they use a forward model based on a 3-D seismic survey and well log data, that recognizes the nonunique inversion (NUI) of seismic/lithologic parameters to generate column subvolumes in the reservoir and horizontal slices of the model volumes. Parameters are averaged across the horizontal slices and plotted to obtain a depth versus parameter trend for the reservoir. Each model cell may then be analyzed within the reservoir model.

Onyia and associates, U.S. Pat. No. 6,473,696 incorporated by reference, coordinate known parameters with seismic velocities by identifying interpreted seismic horizons in seismic data and obtaining estimated seismic velocities corresponding to the interval between seismic horizons at any location within the seismic survey. Neff, U.S. Pat. No. 6,654,692 incorporated by reference, uses “cellular” inversion of like data cells to predict rock properties of a subsurface formation. Seismic survey data and well log data are analyzed by generating synthetic seismic data based on well log data with discrete synthetic data subcells based on seismic attributes; seismic surveys are used to generate discrete reflection data subcells based on the same seismic attributes as the log data; and reflection data subcells are coordinated with a corresponding synthetic data subcells based on the seismic attributes of the reflection and synthetic seismic data. Anno and Routh, US2008189043 incorporated by reference, use prestack inversion of a reference dataset to normalize a second later prestack inversion where the misfit from one dataset to the next identifies changes in the model-difference time lapse inversion.

Velocity modeling uses FWI to determine travel time & amplitude from seismic data including reflection, refraction & transmission data. Tarantola (2005), incorporated by reference, and Pratt (1999 a & b) describe in detail the use and manipulation of a full waveform inversion:

$${d}_{0} \approx F ( m )$$

$${min}_{m} E = \frac{1}{2} {‖ {d}_{0} - F ( m ) ‖}_{2}^{2}$$

$$E ( m + Δ m ) = E ( m ) + Δ {m}^{T} {∇}_{m} E + \frac{1}{2} Δ {m}^{T} H δ m + …$$

where d₀ is the measured data, F(m) is the data model; min E is the minimum error of the model; E(m) being the error across the function; ∇ₘE is the misfit gradient; H is the Hessian associated with the misfit function; and Δm is the change in model. The waveform inversion minimizes the error E(m) iteratively, eventually converging on a model where error is minimized for the current estimation. The minimum error may not be the true convergence of the function as an artificial minimum may be reached or the model may not accurately describe the full dataset in the forward model. The problem has no unique solution, as there exists an infinite number of functions that satisfactorily describe the seismic data.

Therefore to interpolate from known positions to the entire model, an estimate for inversion must be smooth, bounded, and fast to compute. Instead of interpolating over a fixed distance forcing the interpolated solution to have even dispersion over the entire distance, the interpolation is averaged based on lithology by using the dip guide (Hale, 2009). This allows a variety of distances between points as seen in the lithographic models and attributed to features in the actual dataset. By using a DG-FWI analysis the forward model and the data converge rapidly with less processing:

$${d}_{0} \approx F ( m ) \approx F ( Φ x )$$

$${min}_{x} E = \frac{1}{2} {‖ {d}_{0} - F ( Φ x ) ‖}_{2}^{2}$$

$${x}_{k + 1} = {x}_{k} + {α}_{k} {∇}_{x} E$$

$${m}_{k + 1} = Φ {x}_{k + 1}$$

where m is the forward model data at k+1, Φ (phi) is the dip guide, and x is the actual data at k+1. The model for x at k+1 is x at k with the misfit at k. Thus the model m at k+1 is the product of the dip guide Φ and the data x at k+1.

Using the DG-FWI, the calculation burden is estimated to be reduced at least by 8 fold for typical 3D project, amplitude is enhanced across the model, hence the formation properties can be estimated more reliably due to the increased accuracy of the velocity model. Because of the smaller computational burden with DG-FWI, more analyses may be conducted over a larger area to develop a better model with higher resolution than previously obtained. Additionally, the data quality is improved including enhanced amplitudes; thanks to the dip guide, low frequency information can be incorporated into the velocity model. In nature, the dip guide tends to honor the geological compartment, as a result, the DG-FWI produces better velocity model that are often meaningful in terms of geology and stratigraphy (Hale, 2009).

The present invention will be better understood with reference to the following non-limiting examples.

### Example 1

### Synthetic Data Analysis

To test the DG-FWI, model data were generated. A true model was generated by referencing V(z) to a water bottom, adding a deep flat reflector, low velocity gas zone (LVZ) and a high velocity bar (HVB) anomalies. By definition, the starting model was the true model without two anomalies. The true dataset was “generated” with 148 shots with a spacing of 60 ft. Receiver spacing was at 30 ft with a depth interval of 30 ft. The dominant frequency in this model was 10 Hz, quite high for FWI but is intentionally designed to test the robustness of the DG-FWI. This true model was used to generate synthetic data that represent the features and anomalies as described.

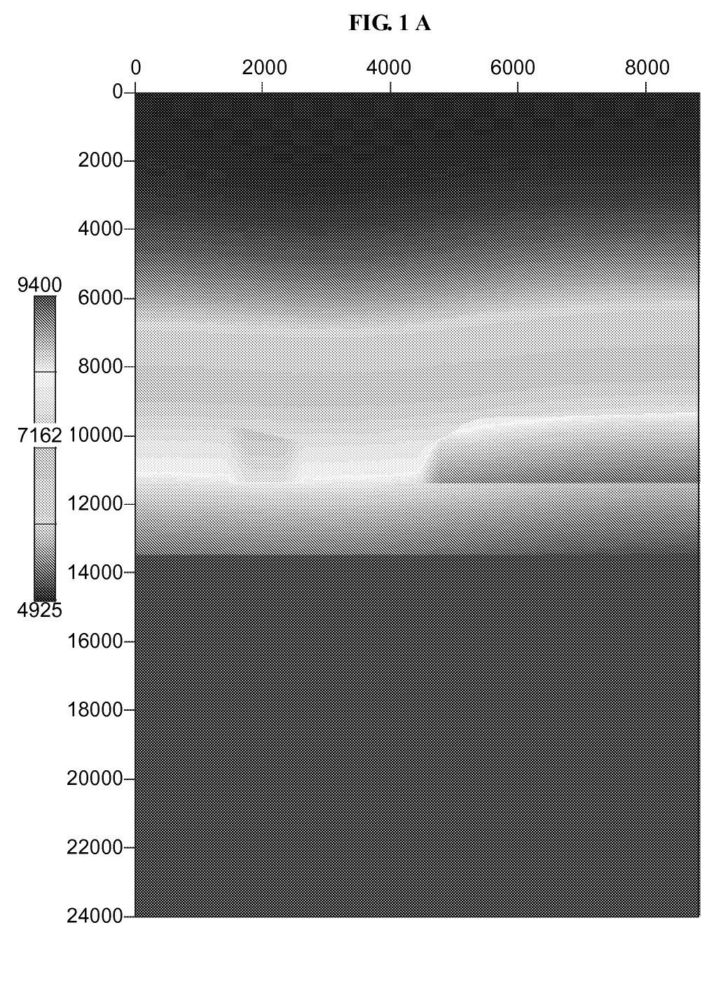

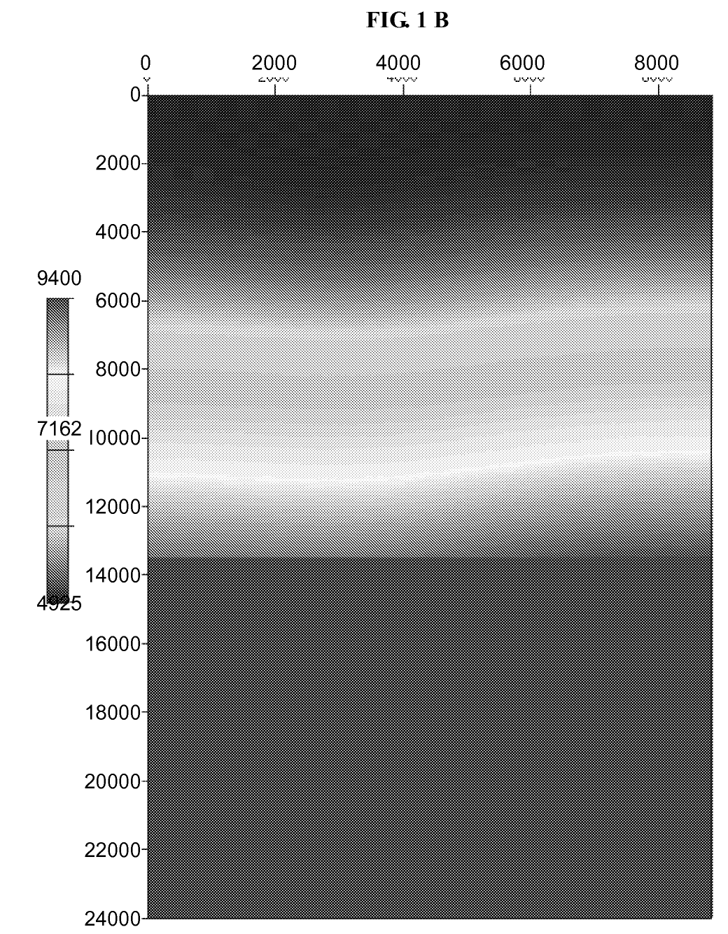

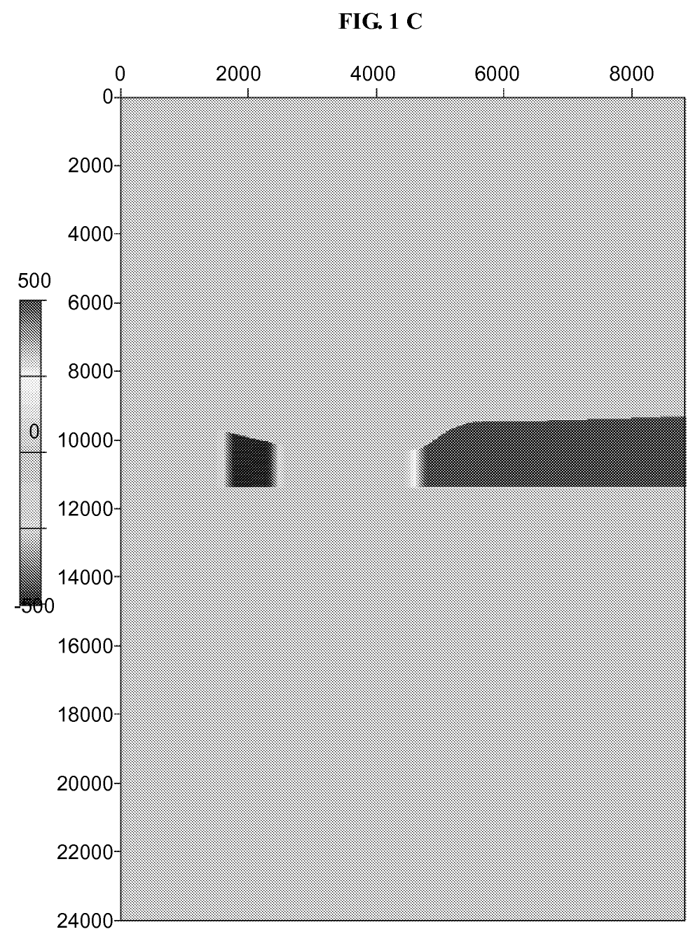

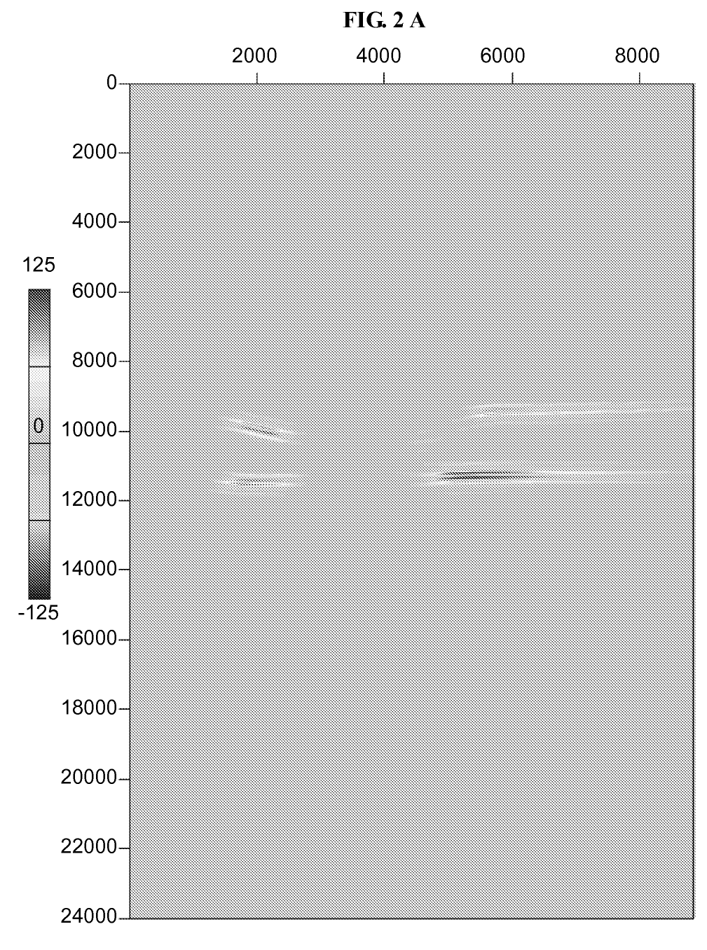

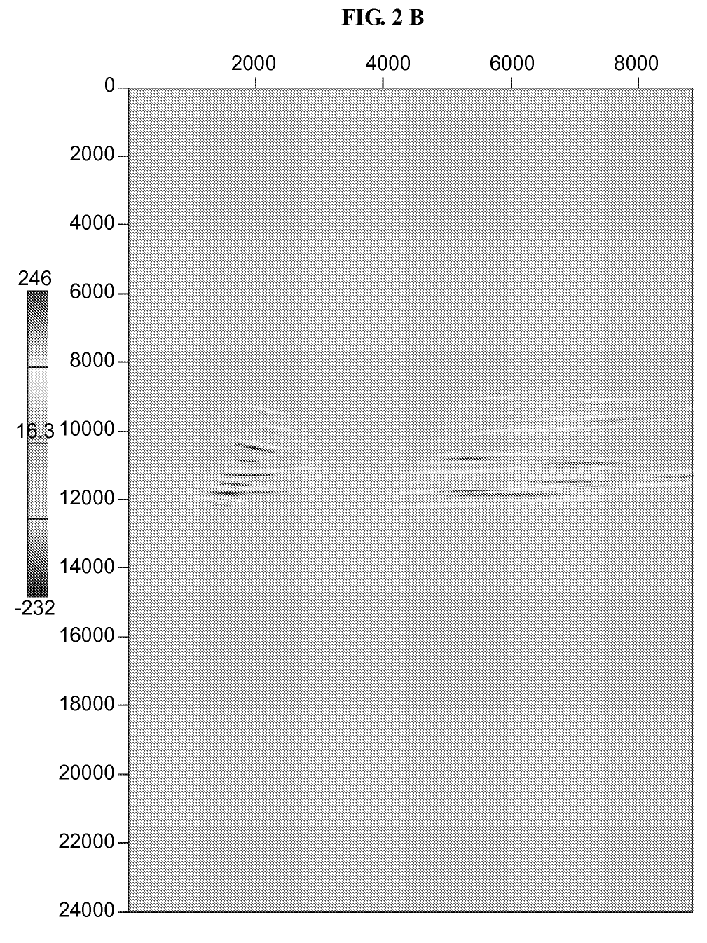

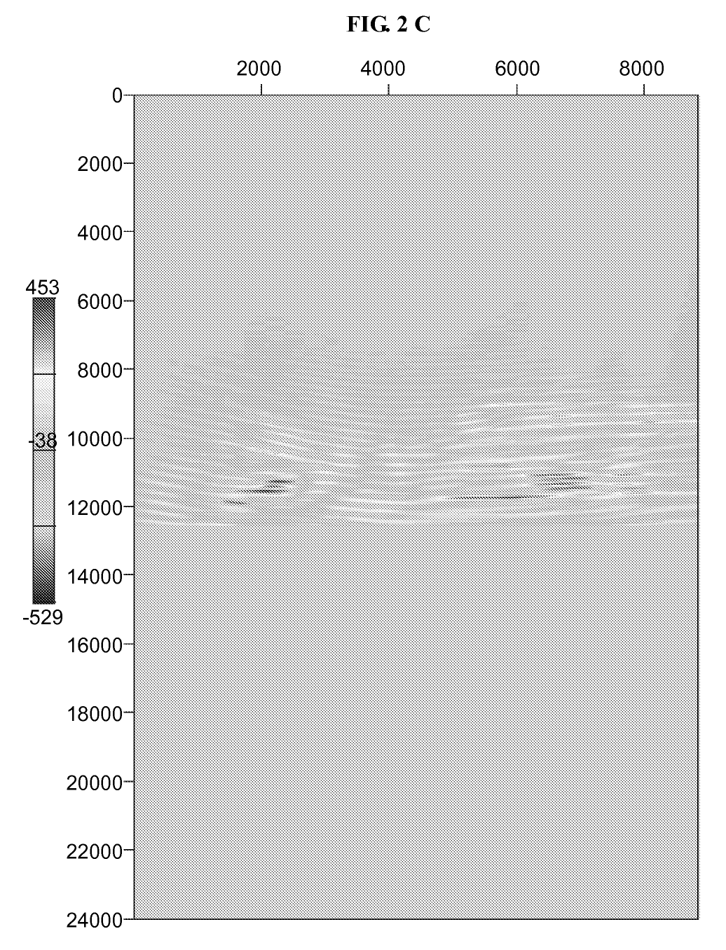

FIG. 1. shows the true model, the starting model and their difference. The true velocity model FIG. 1A shows features including the water bottom, a low velocity zone (LVZ), a high velocity bar (HVB), and a deeper flat reflector. This simple model was analyzed with an initial velocity model FIG. 1B that does not show the LVZ or HVB. The velocity difference in FIG. 1C clearly shows the absence of the LVZ and HVB from the initial velocity model. As expected, forward modeling with the initial velocity model generates a synthetic data F(m) in FIG. 2B that does not contain the same events as that generated by the true velocity model FIG. 2A. From the difference between FIG. 2A and FIG. 2B, we can calculate the misfit gradient FIG. 2C. The difference between FIG. 2A and FIG. 2B shows the initial velocity model does not produce an accurate representation of the synthetic data. A more detailed analysis was required to account for changes in velocity.

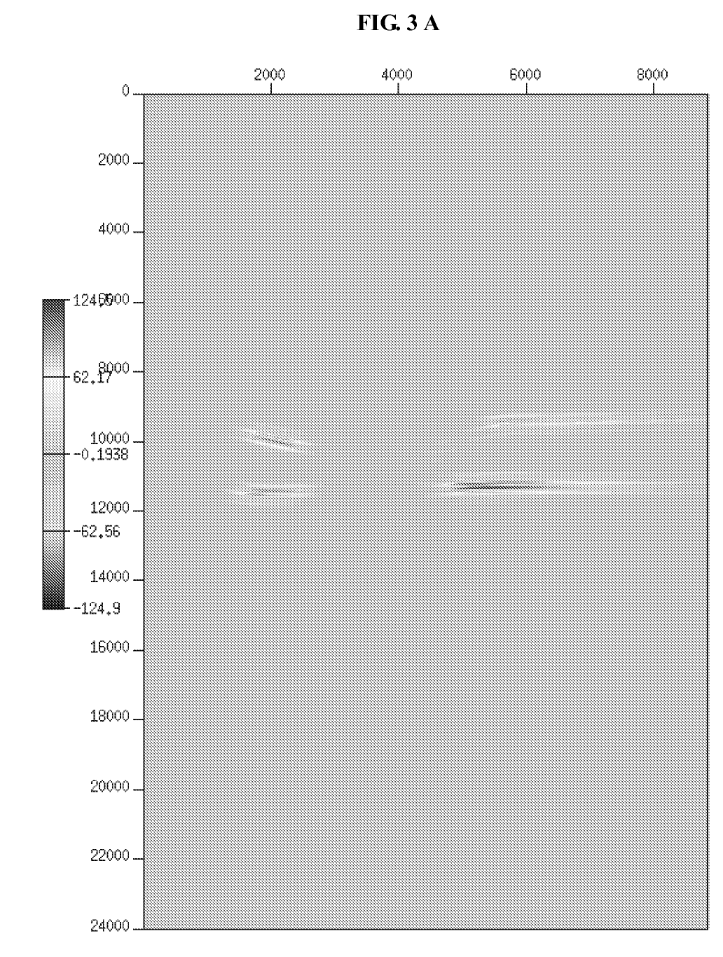

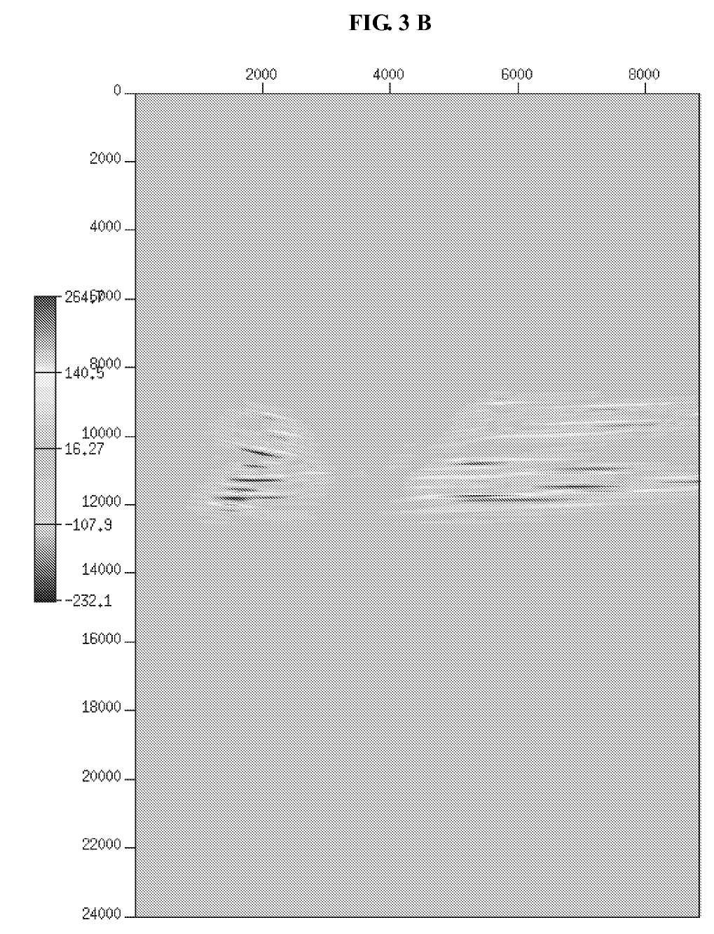

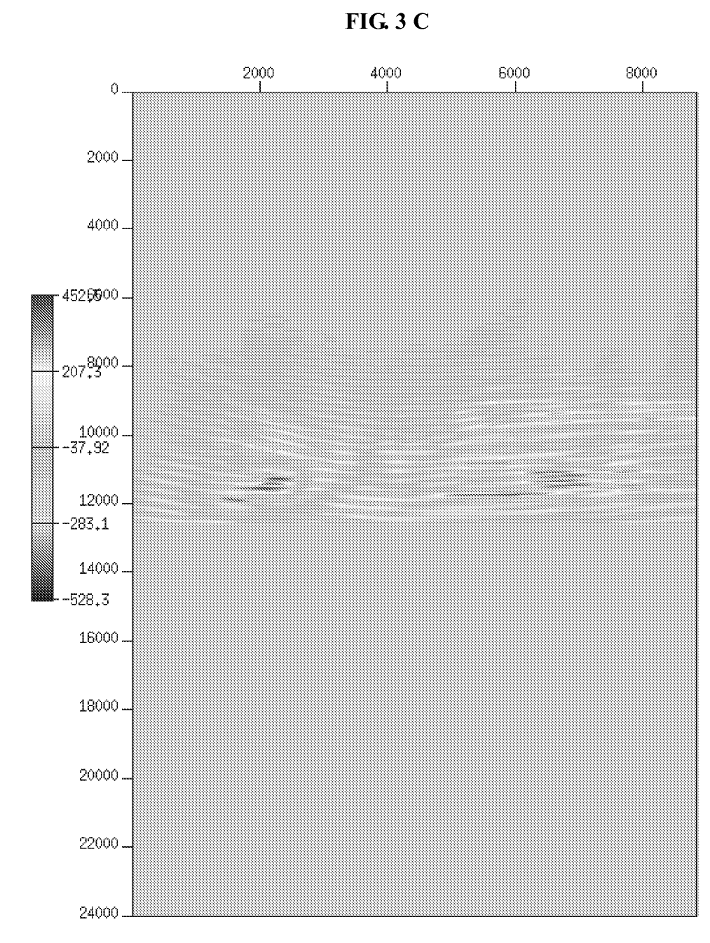

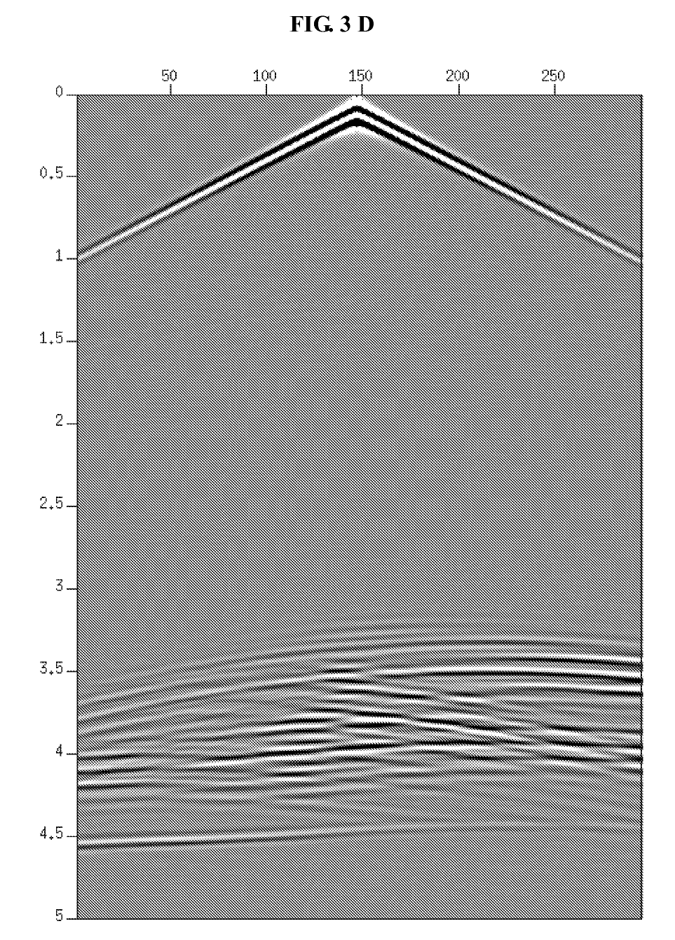

Initially, FWI was used to analyze the data by forward modeling, F(m). When driving F(m) to approach to the synthetic data, d₀, velocity changes are obtained. These velocity changes are easily visualized as shown in FIGS. 3A, 3B, & 3C, with one, five and twenty iterations respectively. In this case the error in the velocity change between the velocity model and the predicted velocity model actually increased after 5 iterations. Indicating using more than 5 iterations of FWI's does not generate a better model. Differences between the modeled data and the true data can also be seen by the artifacts (additional signals) visible in FIG. 3D. Simple FWI analysis with 1, 5 or 20 iterations was insufficient to accurately describe the synthetic model even with known features.

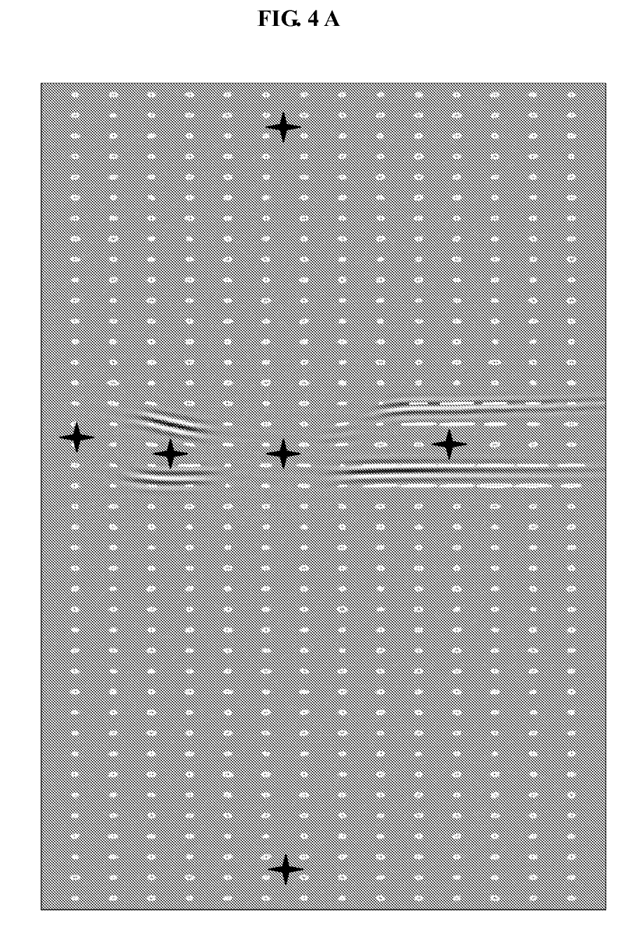

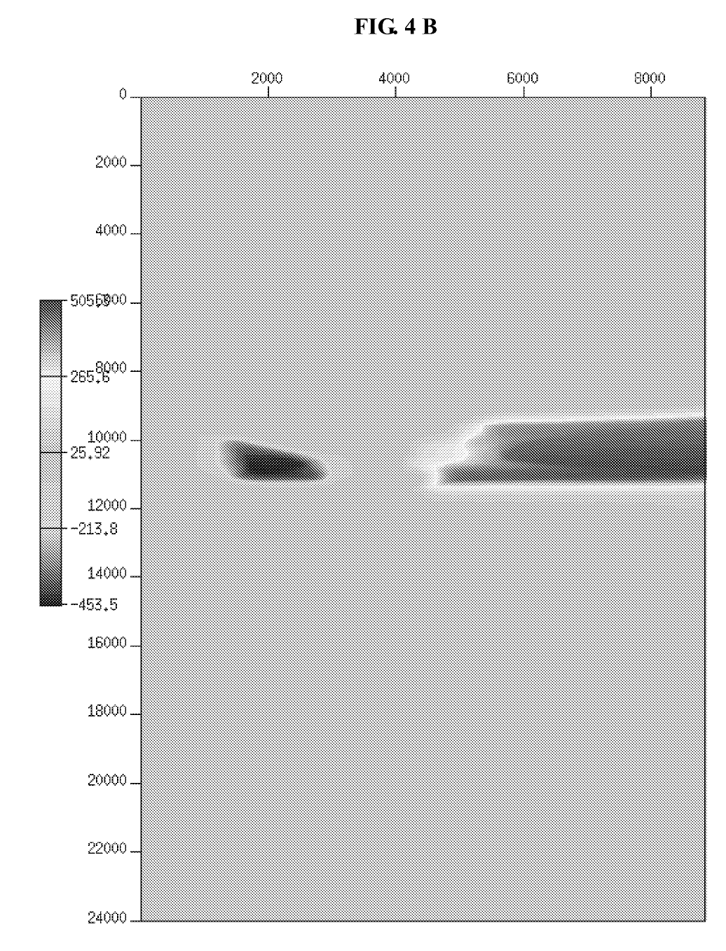

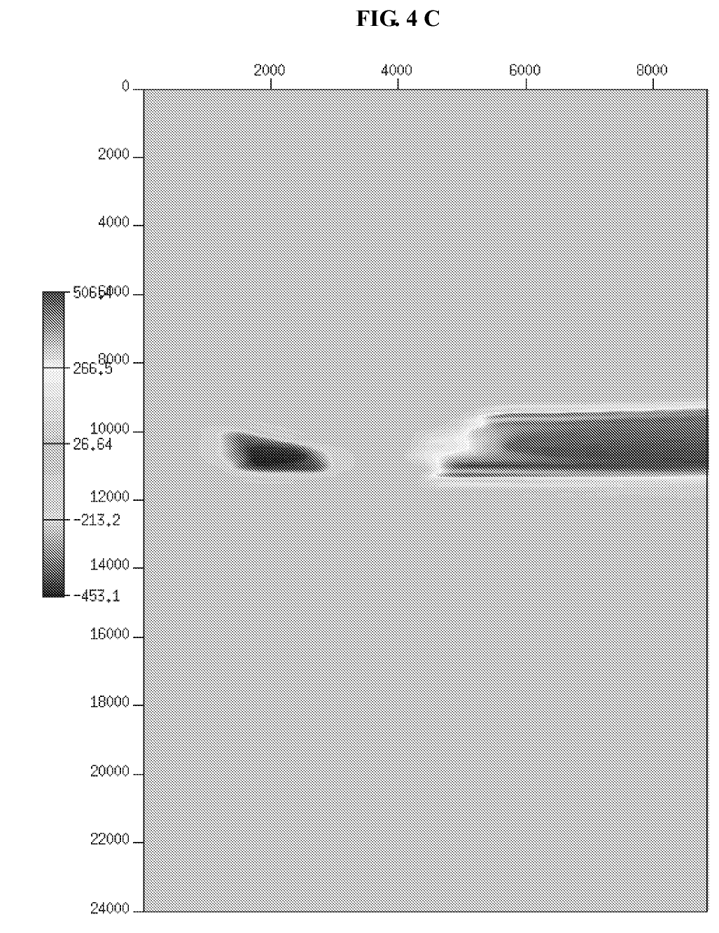

To use a dip-guided FWI, the dip guide (namely, tensor field) is used to guide the FWI. In FIG. 4A, the dip guide is first calculated and seen with features that correlate to the misfit gradient FIG. 1C. With just one iteration of DG-FWI, FIG. 4B, thus accurately recovers differences from the underlying data. An additional simple FWI continues to refine the model, accurately depicting the underlying data as shown in FIG. 4C. The LVZ and HVB boundaries are well defined and accurately reflect the true data that underlie the velocity model. Thus one DG-FWI followed by one FWI, can more accurately match the synthetic data and true data, than the simple FWI after many iterations (see FIG. 3).

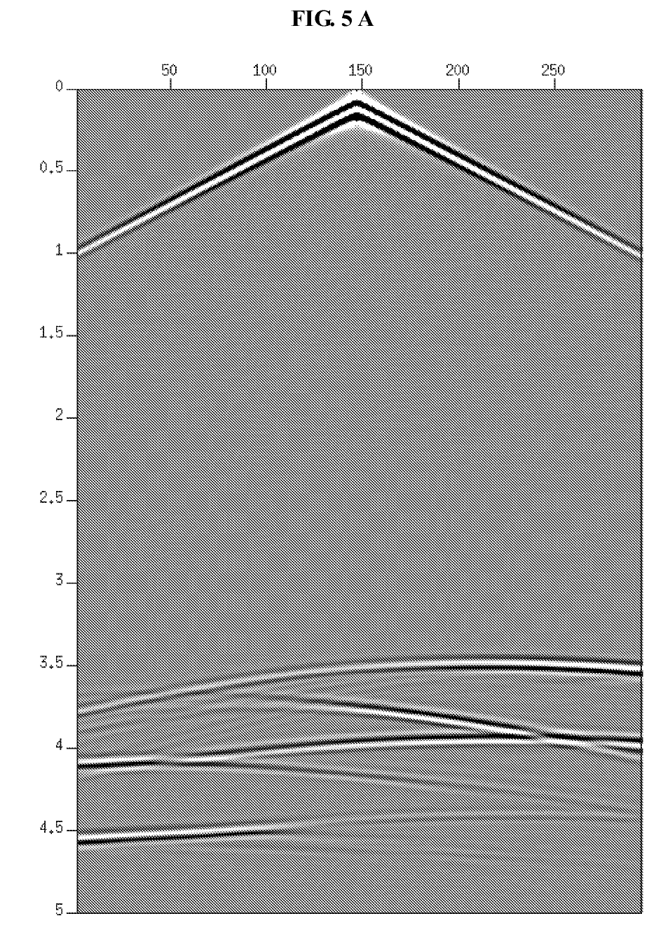

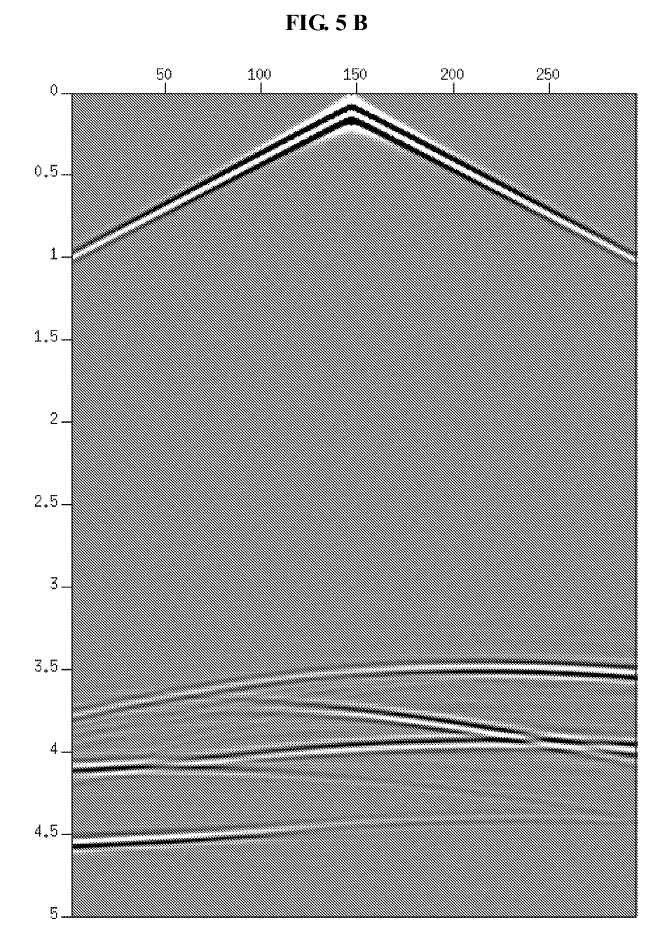

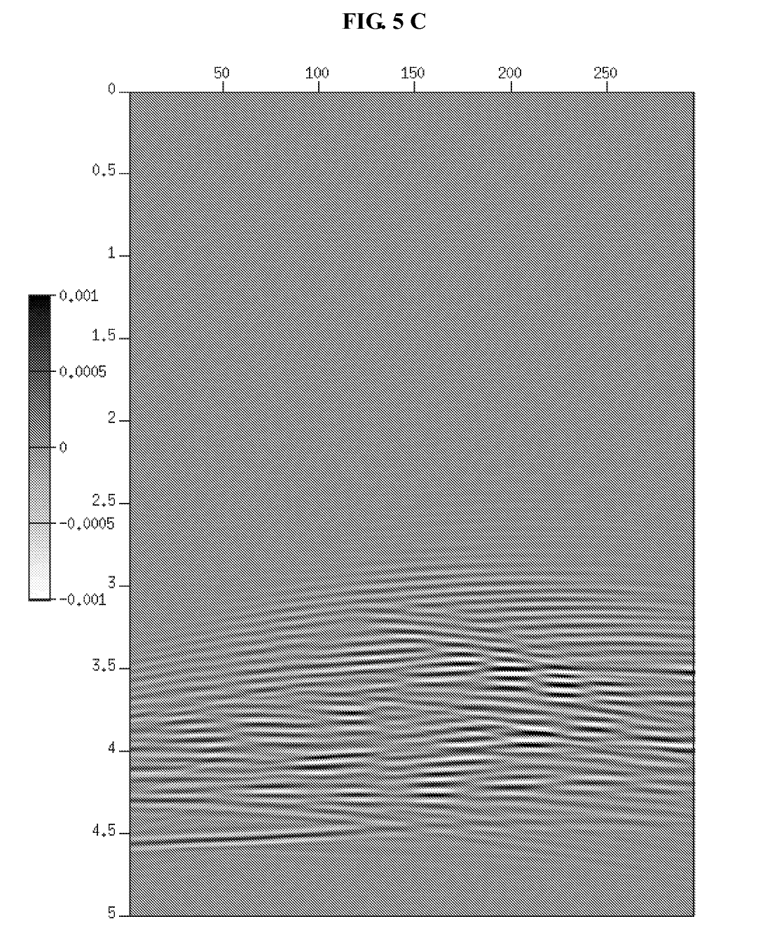

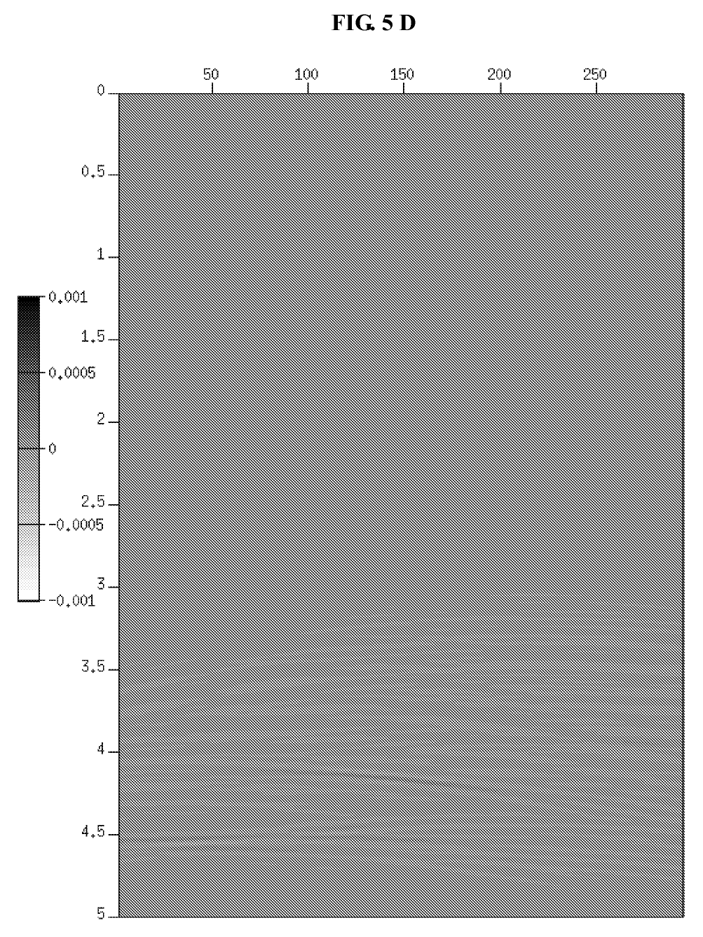

Further, forward modeling of the DG-FWI model, as shown as FIG. 5B, is comparable to the true data, FIG. 5A. There are minimal differences between the DG-FWI modeling data and the true data shown in FIG. 5D. For comparison, by itself the FWI misfit data (FIG. 5C) shows many differences around the features. In this example, FWI may not converge because the 10 Hz Ricker wavelet does not contain as much information as lower frequencies near ˜3 Hz. This clearly demonstrates that the DG-FWI is more robust and works even in the absence of low frequencies.

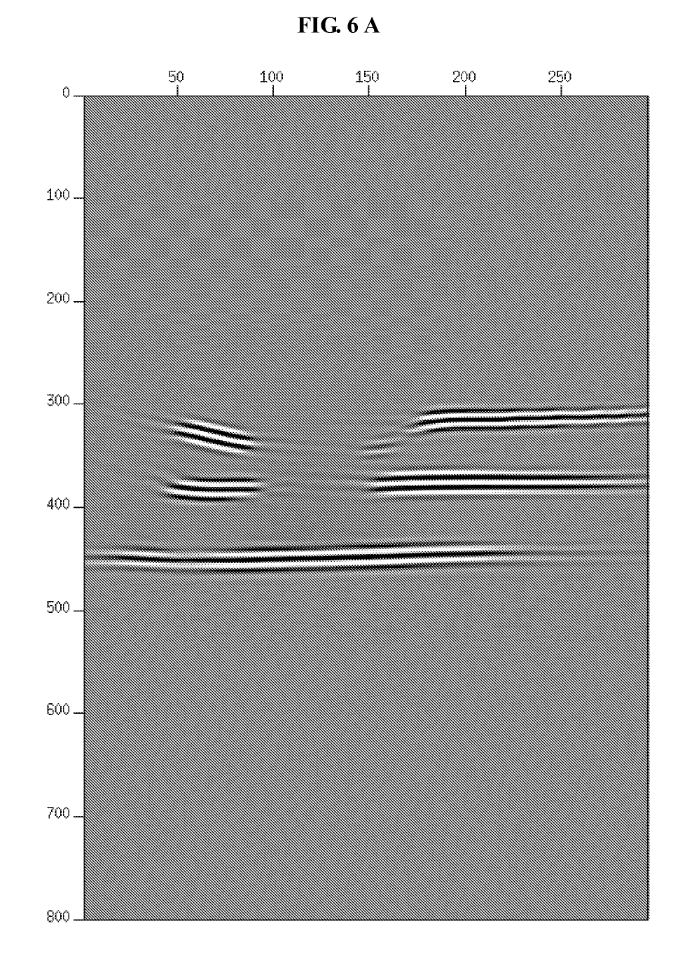

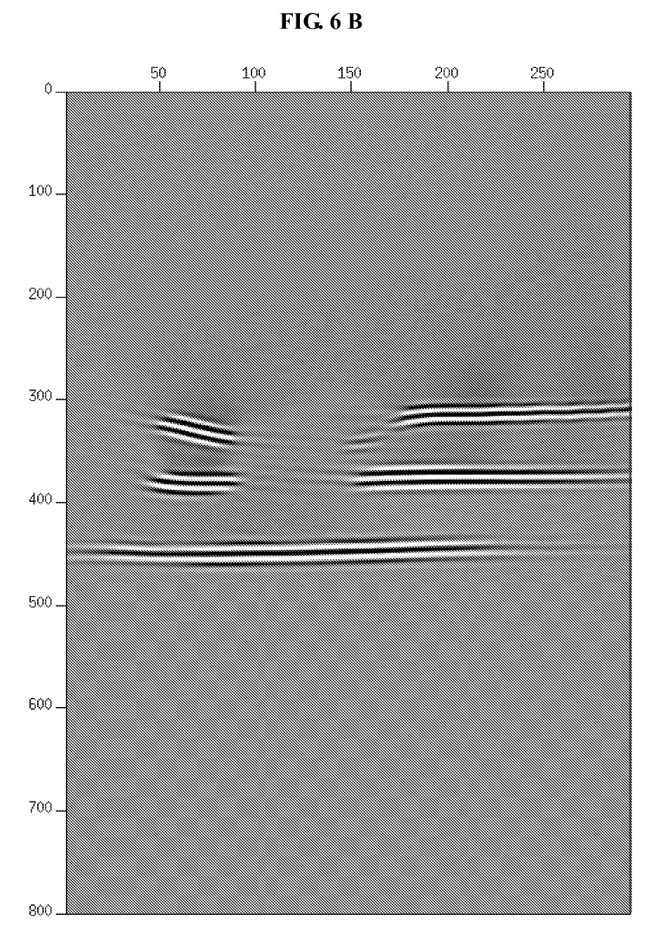

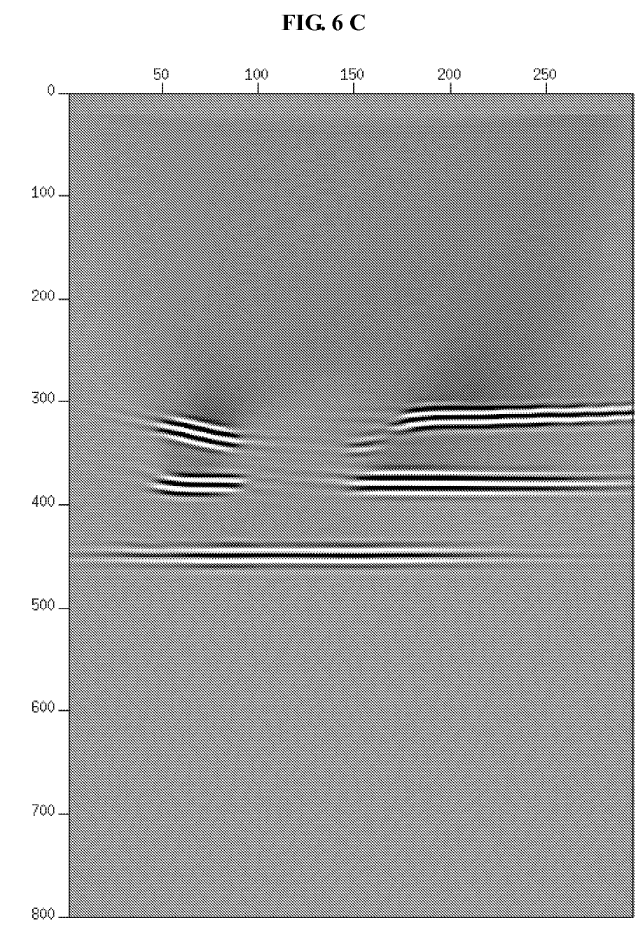

Another way to analyze the velocity model is to monitor the image. The best quality image is generated by Reverse Time Migration (RTM). In FIG. 6 the RTM images are shown for the initial velocity model FIG. 6A, the FWI model FIG. 6B and the DG-FWI model FIG. 6C. For the initial velocity model, FIG. 6A, the deep reflector is not depicted as flat, and the boundaries of the LVZ and HVB are incorrect, shifted from their true location. The FWI velocity model FIG. 6B likewise does not accurately depict the deep reflector because it is curved and the feature boundaries for LVZ and HVB are not improved. Only the DG-FWI depicts the flat deep reflector and properly places the boundaries for the LVZ and HVB. Thus in order to accurately depict even a simple model FIG. 1A, only DG-FWI will accurately identify the true feature (deep reflector) and anomalies (LVZ and HVB) allowing better imaging of the underlying structures.

As shown in FIG. 2-6, DG-FWI can be used to accurately develop a velocity model for seismic data that accurately depicts structures and anomalies. The improved method quickly updates velocity model without an extensive number of iterations. The DG-FWI inversion converges with fewer iterations, and a couple additional FWI iterations may be added to sharpen the boundary of the formation. The DG-FWI works with 10 Hz data, converging to the correct model even when FWI does not converges to the correct velocity due to the lack of low frequencies. This demonstrates that DG-FWI is superior to FWI in dealing with data missing low frequencies (−3 Hz). This is great news since a lack of low frequencies has been a big issue for FWI (Pratt, 1999a; 1999b), both incorporated by reference.

### Example 2

### Anaylisis within a Low Velocity Gas Zone

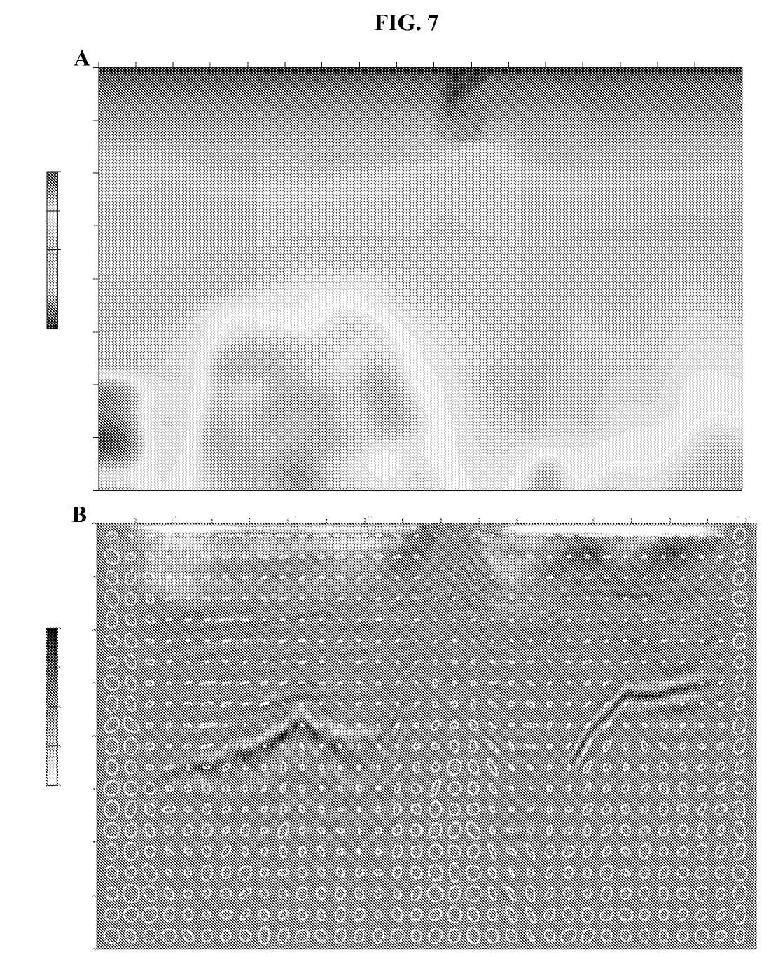

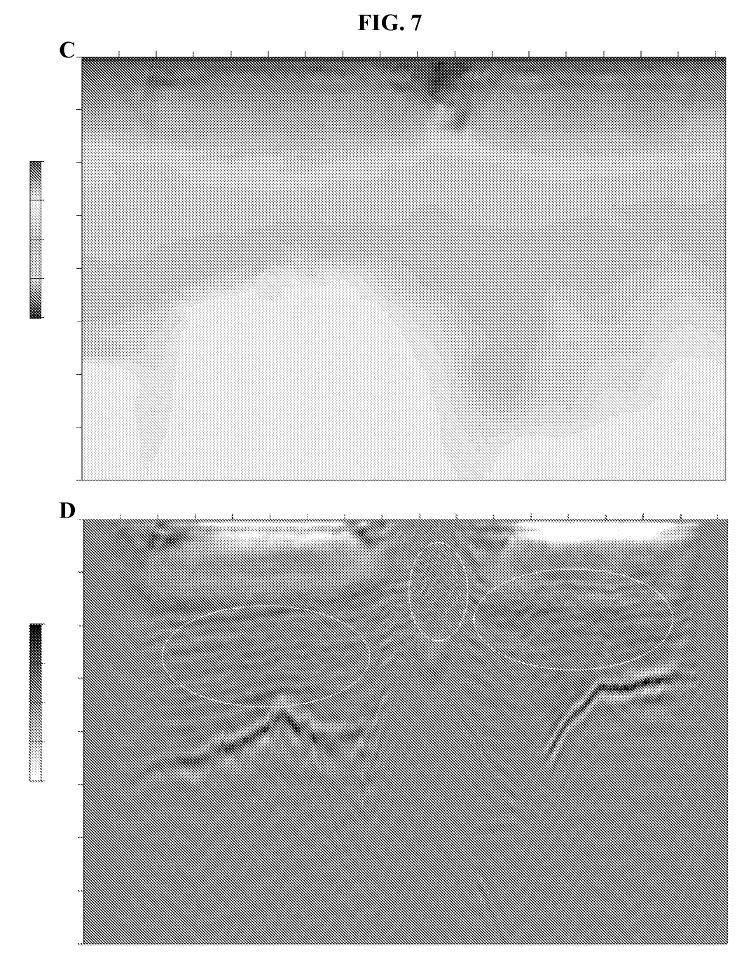

Although DG-FWI accurately assessed the structures and anomalies within a synthetic dataset a more complex system was analyzed to determine applicability to field data. As shown in FIG. 7A, an initial model was used for this test. For this data, each FWI required approximately 2 hours on a 100-node cluster. This data, made up of ˜1200 shots with a 25 m spacing, was acquired to image a gas cloud anomaly. The receivers were spaced at 12.5 m and a depth of 10 m. Anomalies and features for this dataset were not pre-defined and the model was developed based solely on the DG-FWI analyses. An RTM image with the starting model is overlain with the dip guide tensors that will guide the DG-FWI analyses. Although the samples are regularly selected (20×10), the dip guide provides accurate and relevant guidance for the subsequent FWI inversion, and the underlying data dictate the size, shape and direction of the tensor.

The updated DG-FWI velocity model shown in FIG. 7C more accurately reflects the feature boundaries than the original model in FIG. 7A. An RTM image migrated from FWI model shown in FIG. 7D improves contrast and coherence in the image after 8 FWI iterations, but the RTM image from the DG-FWI model (1 DG-FWI plus 1 FWI) shown in FIG. 7E further enhances the image and reveals features invisible with the FWI model. The DG-FWI sharpens the fault structures, which are visible and the true lithography becomes more enhanced, DG-FWI also enhance features and allow visualization where a gas anomaly, located in the top-center, becomes visible.

Overall, the DG-FWI analysis, namely, one DG-FWI followed by one FWI, clearly identifies structural features and gas anomalies allowing the use of less perfect data. The DG-FWI analysis also requires fewer iterations, increasing clarity while decreasing computational requirements. Image resolution can be further clarified by increasing the number of combined DG-FWI and FWI iterations.

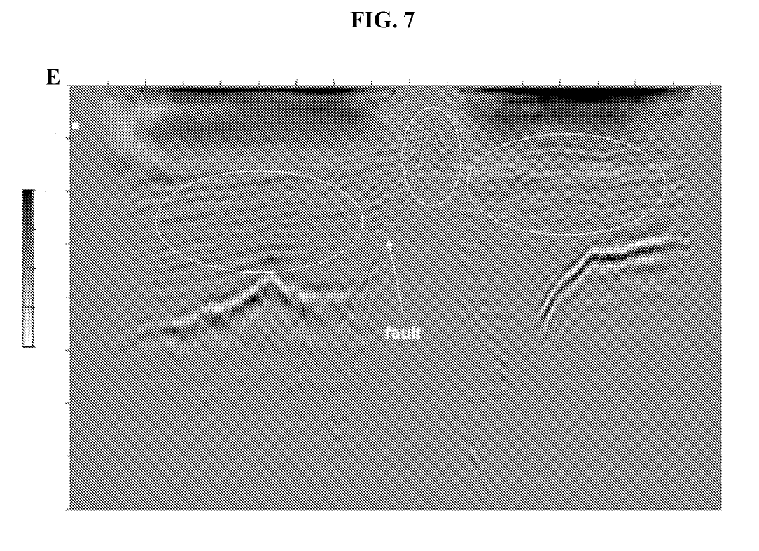

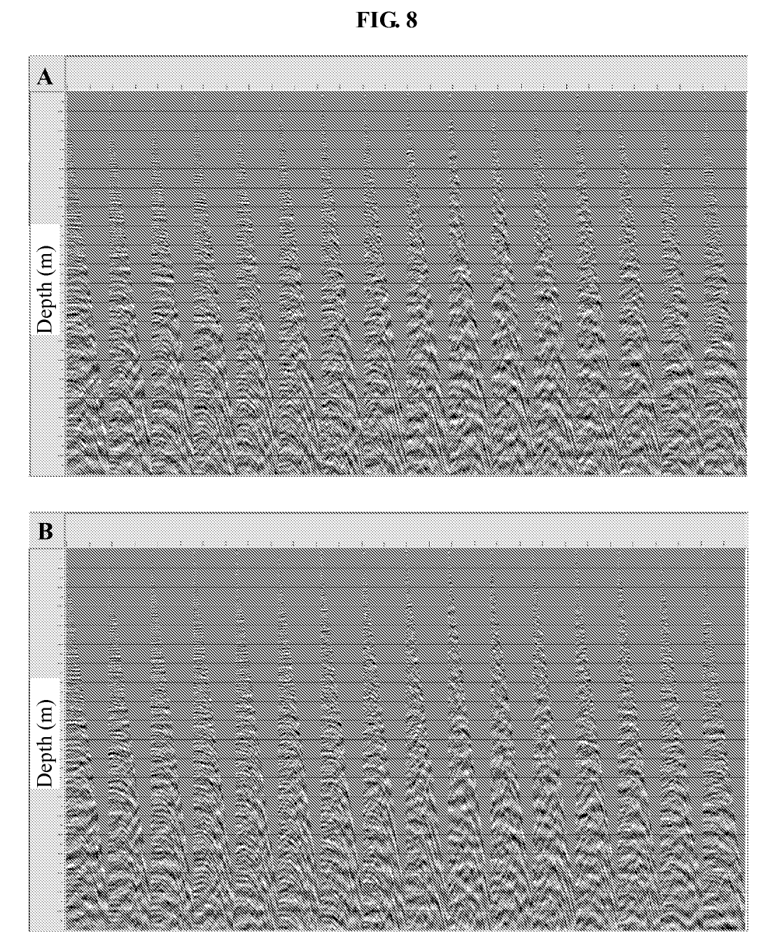

Another way to quality control (QC) the result is to examine the migrated gathers. In most gas zones, data are noisy because the low velocity gas zone absorbs most of the relevant frequencies. The gas anomalies throughout the area obscure the true lithology of the underlying formation. A common image gather (CIG) generates a partial image of the underlying formation. Unfortunately the narrower bandwidth of data reduces the ability to clarify the image and develop a velocity model. As shown in FIG. 8A, the initial velocity model has shown the velocity is too fast in the gas cloud and some of the gathers away from the gas cloud are still not flat. Using DG-FWI, the image gathers generated from the DG-FWI updated model are enhanced, as shown in FIG. 8B, where the size of the gas cloud is reduced and some gathers away from the gas cloud zone become more flat. Not only are the CIG gathers are flattened by DG-FWI, FIG. 8B, but also the resolution is increased, Moreover, the DG-FWI used only ¼ of the run-time by FWI.

DG-FWI improves velocity analysis of seismic data by providing more rapid convergence, increasing resolution and improving model accuracy. DG-FWI analysis is also more robust in dealing with data that lacks low frequencies. Although the systems and processes described herein have been described in detail, it should be understood that various changes, substitutions, and alterations can be made without departing from the spirit and scope of the invention as defined by the following claims.

### REFERENCES

All of the references cited herein are expressly incorporated by reference. Incorporated references are listed again here for convenience:
1. U.S. Pat. No. 5,583,825 (Carrazzone, et al.) “Method for deriving reservoir lithology and fluid content from pre-stack inversion of seismic data,” Exxon Production Res. (1996). See also WO9607935.
2. U.S. Pat. No. 5,835,882 (Vienot, et al.) “Method for determining barriers to reservoir flow,” Phillips Petroleum Co (1998). See also WO9836292.
3. U.S. Pat. No. 5,835,883 (Neff) “Method for determining distribution of reservoir permeability, porosity and pseudo relative permeability,” Phillips Petroleum Co (1998). See also WO9834190.
4. U.S. Pat. No. 6,246,963 (Cross and Lessenger) “Method for predicting stratigraphy,” Platte River Assoc (2001). See also U.S. Pat. No. 6,754,588 and US2002099504.
5. U.S. Pat. No. 6,473,696 (Onyia, et al.) “Method and Process for Prediction of Subsurface Fluid and Rock Pressures in the Earth,” ConocoPhillips (2002). See also U.S. Pat. No. 6,751,558, U.S. Pat. No. 6,977,866 US2002169559, US2003004648, US2004141414, WO02073240, and WO2004018822.
6. U.S. Pat. No. 6,654,692 (Neff) “Method of predicting rock properties from seismic data,” ConocoPhillips (2003). See also WO2004049004.
7. U.S. Pat. No. 6,856,705 (Perez, et al.) “Image Blending By Guided Interpolation,” Microsoft Corp (2004). See also US2004165788, WO2004077347, U.S. Pat. No. 7,038,697, U.S. Pat. No. 7,427,994, US2004164992, and US2005237341.
8. U.S. Pat. No. 6,980,254 (Nishihashi, et al.) “Image interpolation system and image interpolation method,” Sharp KK (2005). See also WO0117243.
9. U.S. Pat. No. 7,254,091 (Gunning, et al.) “Method for estimating and/or reducing uncertainty in reservoir models of potential petroleum reservoirs,” BHP Billiton Innovation Pty (2007).
10. U.S. Pat. No. 7,373,252 (Sherrill) “3D Pre-Stack Full Waveform Inversion,” Western Geco L. L. C. (2007). See also US2007203673.
11. U.S. Pat. No. 7,424,367 (Saltzer, et al.) “Method For Predicting Lithology And Porosity From Seismic Reflection Data,” ExxonMobil Upstream Res. Co. (2008). See also US2008015782 and WO2005119276.
12. U.S. Pat. No. 7,480,206 (Hill) “Methods for earth modeling and seismic imaging using interactive and selective updating,” Chevron U.S.A. (2006). See also US2006056272 and WO2006031481.
13. U.S. Pat. No. 7,519,476 (Tnacheri and Bearnth) “Method of seismic interpretation,” Seisnetics LLC (2009).
14. US2008189043 (Anno) “Direct Time Lapse Inversion of Seismic Data,” ConocoPhillips Co. (2008). See also WO2008097748.
15. Bunks, et al., (1995).
16. Hale, “Image-guided blended neighbor interpolation,” Center for Wave Phenomena, Colorado School of Mines, Golden Colo. (2009).
17. Lailly, (1983).
18. Pratt, “Seismic waveform inversion in frequency domain, Part 1: Theory and verification in physical scale model,” Geophysics, 64, 888-901(1999-a).
19. Pratt, “Seismic waveform inversion in frequency domain, Part 2: Fault delineation in sediments using cross hole data,” Geophysics, 64, 902-914 (1999-b).
20. Tarantola, A., “Inverse Problem Theory: Methods for Data Fitting and Parameter Estimation” Elsevier, Amsterdam, (1987).
21. Yang & Meng, (1996).

We claim:

1. A method of developing a velocity model comprising:
a) obtaining seismic data,
b) calculating a misfit gradient, ∇Eₘ,
c) preparing a dip-guide Φ from the seismic data,
d) identifying measurement points, x,
e) calculating the misfit gradient with respect to the measurement points, ∇Eₓ, and
f) developing a full waveform inversion model, m_{DG}=Φx, using the dip-guide Φ, wherein the dip-guide is used to condition the full waveform inversion.

2. The method of claim 1, wherein steps (b), (c), (d), (e) or (f) are repeated for one or more iterations (k) to improve forward model resolution.

3. The method of claim 1, wherein said dip-guided inversion model is represented by mₖ=Φxₖ or Δmₖ=ΦΔxₖ, where k is the iteration index.

4. The method of claim 1, wherein the forward model is analyzed for change in the misfit gradient and a full waveform inversion is repeated 1 or more times to improve forward model resolution.

5. The method of claim 1, wherein the seismic data contains 1 or more anomalies including low velocity zones, high velocity zones, gas zones, salt zones, or other feature.

6. The method of claim 1, wherein the changes in misfit are monitored for migration.

7. The method of claim 1, wherein said seismic data is selected from the group consisting of refraction tomography, reflection tomography, transmission tomography, and combinations thereof.

8. The method of claim 1, wherein the full waveform modeling iterations are reduced by dip-guided inversion modelling if compared to full waveform modeling of the initial seismic data.

9. The method of claim 1, wherein the velocity analysis system is selected from the group consisting of 3D Model Builder, Seismitarium, ModSpec, Vest3D, Velocity Model Building (VMB), and Reflection Tomography.

10. A method of developing a velocity model comprising:
a) obtaining seismic data,
b) calculating the misfit gradient, ∇Eₘ,
c) developing a full waveform inversion model change Δm_{FWI} using the misfit gradient ∇Eₘ,
d) developing a new full waveform inversion model m from the previous full wavefrom inversion model m=m_{DG}+Δm_{FWI}, and
e) repeating steps (b), (c), or (d) one or more times to increase resolution
wherein a dip-guided inversion model provides an initial model for full waveform inversion.

11. The method of claim 10, wherein steps (b), (c), (d), (e) or (f) are repeated for one or more iterations (k) to improve forward model resolution.

12. The method of claim 10, wherein said dip-guided inversion model is represented by mₖ=Φxₖ or Δmₖ=ΦΔxₖ, where k is the iteration index.

13. The method of claim 10, wherein the forward model is analyzed for change in the misfit gradient and a full waveform inversion is repeated 1 or more times to improve forward model resolution.

14. The method of claim 10, wherein the seismic data contains 1 or more anomalies including low velocity zones, high velocity zones, gas zones, salt zones, or other feature.

15. The method of claim 10, wherein the changes in misfit are monitored for migration.

16. The method of claim 10, wherein said seismic data is selected from the group consisting of refraction tomography, reflection tomography, transmission tomography, and combinations thereof.

17. The method of claim 10, wherein the full waveform modeling iterations are reduced by dip-guided inversion modelling if compared to full waveform modeling of the initial seismic data.

18. The method of claim 10, wherein the velocity analysis system is selected from the group consisting of 3D Model Builder, Seismitarium, ModSpec, Vest3D, Velocity Model Building (VMB), and Reflection Tomography.

19. A method of developing a velocity model comprising:
a) obtaining seismic data on a computer readable media,
b) transferring the seismic data to a velocity analysis system,
c) calculating a dip-guide from the seismic data,
d) performing a full waveform inversion model in the velocity analysis system,
wherein the dip-guide is used to condition the full waveform inversion.

20. The method of claim 19, wherein steps (b), (c), (d), (e) or (f) are repeated for one or more iterations (k) to improve forward model resolution.

21. The method of claim 19, wherein said dip-guided inversion model is represented by mₖ=Φxₖ or Δmₖ=ΦΔxₖ, where k is the iteration index.

22. The method of claim 19, wherein the forward model is analyzed for change in the misfit gradient and a full waveform inversion is repeated 1 or more times to improve forward model resolution.

23. The method of claim 19, wherein the seismic data contains 1 or more anomalies including low velocity zones, high velocity zones, gas zones, salt zones, or other feature.

24. The method of claim 19, wherein the changes in misfit are monitored for migration.

25. The method of claim 19, wherein said seismic data is selected from the group consisting of refraction tomography, reflection tomography, transmission tomography, and combinations thereof.

26. The method of claim 19, wherein the full waveform modeling iterations are reduced by dip-guided inversion modelling if compared to full waveform modeling of the initial seismic data.

27. The method of claim 19, wherein the velocity analysis system is selected from the group consisting of 3D Model Builder, Seismitarium, ModSpec, Vest3D, Velocity Model Building (VMB), and Reflection Tomography.
